(19) United States
(12) Patent Application Publication
(10) Pub. No.: US 2010/0027144 A1
(43) Pub. Date: Feb. 4, 2010

(54) Articles with protective coating

(75) Inventors: Desaraju V. Varaprasad, Ann Arbor, MI (US); Yiwei Lu, Ann Arbor, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 12/222,068

(22) Filed: Jul. 31, 2008

(51) Int. Cl. G02B 1/10; B05D 5/06; B32B 17/06

(52) U.S. Cl. 359/870; 427/165; 428/428; 428/426

(57) ABSTRACT

A first-surface mirror or other substrate includes protective coating and is for use in a solar collector, projection television, or the like. In certain example embodiments, a protective coating is formed over a reflective coating of a first surface mirror. In other aspects, this application is related to other coated articles, including, for example, articles (such as insulating glass (IG) window units) having coatings providing for low emissivity. In certain example embodiments, the protective coating may comprise organic materials containing alkyl chains or fluoro-alkyl chains and reactive functionalities comprising silicon and/or phosphorous so as to protect the reflective coating and improve durability.

In some respects, this application is related to a first-surface mirror including a protective coating thereon for use in a solar collector, projection television, or the like. In certain example embodiments of this invention, a protective coating is formed over a glass substrate of a first surface mirror. In other aspects, this application is related to other coated articles, including articles (such as insulating glass (IG) window units) having coatings providing for low emissivity. In certain example embodiments, the protective coating may comprise an alkyl chain or a fluoro-alkyl chain and at least one reactive functionality comprising silicon and/or phosphorous so as to protect the reflective coating and improve durability.

### BACKGROUND AND SUMMARY OF EXAMPLE EMBODIMENTS OF THE INVENTION

Mirrors for various uses are known in the art. For example, see U.S. Pat. Nos. 5,923,464 and 4,309,075 (all hereby incorporated herein by reference). Mirrors are also known for use in projection televisions and other suitable applications. In the projection television context, see for example U.S. Pat. Nos. 6,275,272, 5,669,681 and 5,896,236 (all hereby incorporated herein by reference).

One type of mirror is a second or back surface mirror (most common), while another type of mirror is a first or front surface mirror (less common). Back surface mirrors typically include a glass substrate with a reflective coating on a back surface thereof (i.e., not on the front surface which is first hit by incoming light). Incoming light passes through the glass substrate before being reflected by the coating in a second surface mirror. Thus, reflected light passes through the glass substrate twice in back or second surface mirrors; once before being reflected and again after being reflected on its way to a viewer. In certain instances, passing through the glass substrate twice can create ambiguity in directional reflection and imperfect reflections may sometimes result. Mirrors such as bathroom mirrors, bedroom mirrors, and architectural mirrors are typically back or second surface mirrors so that the glass substrate can be used to protect the reflective coating provided on the rear surface thereof.

In applications where more accurate reflections are desired, front (or first) surface mirrors are often used. In front/first surface mirrors, a reflective coating provided on the front surface of the glass substrate so that incoming light is reflected by the coating before it passes through the glass substrate (e.g., see FIG. 1). Since the light to be reflected does not have to pass through the glass substrate in first surface mirrors (in contrast to rear surface mirrors), first surface mirrors generally have higher reflectance than do rear surface mirrors, and no double reflected image. Example front surface mirrors (or first surface mirrors) are disclosed in U.S. Pat. Nos. 5,923,464 and 4,780,372 (both incorporated herein by reference).

Many first surface mirror reflective coatings include a dielectric layer(s) provided on the glass substrate over a reflective layer (e.g., Al or Ag). Unfortunately, when the coating becomes scratched or damaged in a front surface mirror, this affects reflectivity in an undesirable manner as light must pass through the scratched or damaged layer(s) twice before reaching the viewer (this is not the case in back/rear surface mirrors where the reflective layer is protected by the glass). Coatings typically used in this regard are not very durable, and are easily scratched or otherwise damaged leading to reflectivity problems. Thus, it can be seen that front/first surface mirrors are very sensitive to scratching. Other possible cosmetic problems associated with first surface mirrors include pinhole formations, corrosion, adhesion, and/or reflectivity level.

For example, FIG. 1 illustrates a first surface mirror including glass/Al/SiO₂/TiO₂, where the aluminum (Al) reflective layer is deposited directly onto the glass substrate. Such mirrors may suffer from problems such as poor adhesion, pinholes, poor scratch and abrasion resistance, and other durability and cosmetic problems. These durability problems may be particularly evident when float glass (soda lime silica glass) is used as the substrate.

Uses of first surface mirrors, such as solar collectors, are known in the art. Example solar collectors are disclosed in U.S. Pat. Nos. 5,347,402, 4,056,313, 4,117,682, 4,608,964, 4,059,094, 4,161,942, 5,275,149, 5,195,503 and 4,237,864, the disclosures of which are hereby incorporated herein by reference. Solar collectors include at least one mirror (e.g., parabolic or other type of mirror) that reflects incident light (e.g., sunlight) to a focal location such as a focal point. In certain example instances, a solar collector includes one or more mirrors that reflect incident sunlight and focus the light at a common location. For instance, a liquid to be heated may be positioned at the focal point of the mirror(s) so that the reflected sunlight heats the liquid (e.g., water, oil, or any other suitable liquid) and energy can be collected from the heat or steam generated by the liquid.

FIG. 2 is a schematic diagram of a conventional solar collector, or a part thereof, where a parabolic mirror 1 reflects incident light from the sun 3 and focuses the reflected light on a black body 5 that absorbs the energy of the sun's rays and is adapted to transfer that energy to other apparatus (not shown). By way of example only, the black body 5 may be a conduit through which a liquid or air flows where the liquid or air absorbs the heat for transfer to another apparatus. As another example, the black body 5 may be liquid itself to be heated, or may include one or more solar cells in certain example instances.

FIG. 3 is a cross sectional view of a typical mirror used in conventional solar collector systems. The mirror of FIG. 3 includes a reflective coating 7 supported by a glass substrate 9, where the glass substrate 9 is on the light incident side of the reflective coating 7 (i.e., the incident light from the sun must pass through the glass before reaching the reflective coating). This type of mirror is a second or back surface mirror. Incoming light passes through the glass substrate 9 before being reflected by the coating 7; the glass substrate 9 is typically from about 4-5 mm thick. Thus, reflected light passes through the glass substrate twice in back surface mirrors; once before being reflected and again after being reflected on its way to a viewer. Second or back surface mirrors, as shown in FIG. 3, are used so that the glass 9 can protect the reflective coating 7 from the elements in the external or ambient atmosphere in which the mirror is located (e.g., from rain, scratching, acid rain, wind-blown particles, and so forth).

Unfortunately, the glass 9 in the second surface or back surface mirror of FIGS. 2 and 3 absorbs some of the energy of the sun's rays. For example, the glass 9 may absorb certain infrared, ultraviolet and/or visible light from the sun's rays, thereby preventing such absorbed light from reaching the black body to be heated in the solar collector. This is undesirable in that energy is being wasted due to the absorption of energy by the glass of the mirror.

Thus, it will be appreciated that there exists a need in the art for a more efficient mirror for use in solar collectors and the like. In particular, it would be desirable if less energy was wasted.

FIG. 4 is a schematic diagram illustrating the mirror of any of the embodiments discussed herein being used in the context of a projection television (PTV). Light is directed toward and reflected by the mirror which in turn directs the light toward a Fresnel lens, contrast enhancement panel, and/or protective panel after which it ultimately proceeds to a viewer. The improved features of the mirrors discussed herein may enable an improved PTV to be provided.

Optical coatings especially those consisting of single or plural metal layers can be prone to external damages occurred during cleaning and handling due to the softness of these metal layers. In order to improve the durability, metallic layers are generally either embedded within or under hard materials such as oxides, nitrides or oxynitrides. However, the protection is limited because of the restricted thickness of those hard material layers that plays a key role in its optical functionalities especially in coatings designed to have functionalities in UV, visible, near IR, and/or short IR region, such as, for example, silver-based low emissivity coatings on glass for residential or architecture buildings and aluminium-based first surface mirror for rear projection televisions.

Therefore, there is a need to have a coating to prevent optical coatings from mechanical damages and contaminations, and at the same time, without substantially altering an optical response of the coating. That is, this protective coating is preferably substantially transparent in the interested wavelength region and have a thickness less than the shortest interested wavelength for which the optical coating is designed.

Long chain organic materials having reactive end groups based on silicon and phosphorous are generally known to form self-assembled monolayers on glass surfaces. Silanes containing short organic chains, such as methyl trichlorosilane, have also been used to produce monolayers of coatings on glass surface. The reactive functional groups form chemical bonds to the hydroxyl groups present on glass surface, and the organic chains point away from the glass surface and this results in change of surface characteristics of the glass. Thus, the generally hydrophilic nature of the glass surface changes to generally hydrophobic in nature which manifests in the form of high contact angles for water droplets. Organic chains containing fluorine atoms may also produce similar effects on glass surface. In addition to altering the chemical nature of the surface, these coatings may impart lubricity to surface, which can result in a lower coefficient of friction and enhanced scratch resistance. Such an organic coating with a thickness less than several nm may be capable of imparting a significant hydrophobic character when applied to optical coating surfaces as well, and the enhanced lubricity may cause coated substrates to be less prone to mechanical damage and may also reduce surface contaminations, such as dust or fingerprints.

In certain example embodiments of this invention, a first (or front) surface mirror (FSM) is used in applications such as solar collectors or optoelectronics, such as rear-projection televisions. In a first or front surface mirror, the reflective coating is provided on the front surface of the glass substrate so that incoming light is reflected by the coating before it passes through the glass substrate. Since the light to be reflected does not have to pass through the glass substrate in first surface mirrors (in contrast to rear or second surface mirrors), first surface mirrors generally have higher reflectance than rear surface mirrors and less energy is absorbed by the glass. Thus, the first surface mirrors are more energy efficient than are rear or second surface mirrors. Certain example first surface mirror reflective coatings include a dielectric layer(s) provided on the glass substrate over a reflective layer (e.g., Al or Ag).

Unfortunately, if the overcoat dielectric layer becomes scratched or damaged in a front surface mirror, this may affect reflectivity in an undesirable manner as light must pass through the scratched or damaged layer(s) twice before reaching the viewer (this is not the case in back/rear surface mirrors where the reflective layer is protected by the glass). Dielectric layers typically used in this regard are not very durable, and are easily scratched or otherwise damaged leading to reflectivity problems. Thus, it can be seen that front/first surface mirrors may be very sensitive to scratching or other damage of the dielectric layer(s) which overlie the reflective layer.

It will be apparent from the above that there exists a need in the art for a first/front surface mirror for use in solar collectors, rear projection televisions, and/or the like that is less susceptible to scratching or other damage of dielectric layer(s) overlying the reflective layer.

In certain example embodiments of this invention, a first-surface mirror (same as front surface mirror) is provided with a reflective coating and a protective coating provided over at least the reflective coating. The reflective coating may be formed in any suitable manner such as via sputtering or spraying. The protective coating protects the reflective coating of the mirror from elements in the external or ambient atmosphere in which the mirror is located (e.g., from rain, scratching, acid rain, wind-blown particles, and so forth). In certain example embodiments, the coating is applied over the reflective coating in a wet form before drying. In certain example embodiments, the protective coating may comprise an alkyl chain or a fluoro-alkyl chain and at least one reactive functionality comprising silicon and/or phosphorous so as to protect the reflective coating and improve durability.

First-surface mirrors according to certain example embodiments of this invention may be used in applications such as one or more of: parabolic-trough power plants, compound parabolic concentrating collectors, solar dish-engine systems, solar thermal power plants, and/or solar collectors, which rely on mirror(s) to reflect and direct solar radiation from the sun. In certain embodiments, this invention may be used in other applications involving a first-surface mirror, such as optoelectronics, including rear-projection televisions or the like. In certain example instances, the mirror(s) may be mounted on a steel or other metal based support system.

In some example embodiments, the present invention relates to or other substrates, such as low emissivity (low-E) coatings. Low-E coatings for glass are well known. In this regard, U.S. Pat. Nos. 5,344,718, 5,425,861, 5,770,321, 5,800,933 (the entire content of each being incorporated expressly herein by reference) disclose coatings formed of a multiple layer coating “system”. In certain embodiments, low-E glass coatings have a layer of a transparent dielectric material (e.g., TiO₂, Bi₂O₃, PbO or mixtures thereof) adjacent the glass substrate and a sequence of multiple layers of, for example, Si₃N₄, nickel (Ni), nichrome (Ni:Cr), nitrided nichrome (NiCrN) and/or silver (Ag). Low-E coatings are, in some instances, heat-treatable—that is, the coating is capable of being subjected to the elevated temperatures associated with conventional tempering, bending, heat-strengthening or heat-sealing processes without significantly adversely affecting its desirable characteristics. In an aspect, certain embodiments of the present invention relate to a very thin coating (e.g., a few nanometers or less) that can provide hydrophobic and low frictional surface without (or very little) impacting the optical performance of the optical coating to which it is applied.

In certain example embodiments, the protective coating is applied in wet form at a rather low temperature (e.g., room temperature) so that underlying reflective coating is not damaged during the application of the protective coating.

In certain example embodiments, there is a method of making a first surface mirror, the method comprising: forming a reflective coating on a glass substrate; forming a protective coating on the glass substrate over the reflective coating, the protective coating being formed from a protective coating composition comprising at least one organic material containing alkyl chains or fluoro-alkyl chains and reactive functionalities comprising silicon and/or phosphorous.

In certain example embodiments, there is a first surface mirror, comprising: a reflective coating supported by a glass substrate; and a protective coating provided on the glass substrate over the reflective coating of the first surface mirror; wherein the protective coating comprises at least one organic material containing alkyl chains or fluoro-alkyl chains and reactive functionalities comprising silicon and/or phosphorous.

In certain example embodiments, there is a coated article, comprising: a substrate; and a protective coating provided on the substrate; wherein the protective coating comprises at least one organic material containing alkyl chains or fluoro-alkyl chains and reactive functionalities comprising silicon and/or phosphorous. The coated article may include a glass substrate, such as one supporting a solar management layer having low-emissivity properties. In some instances, the solar management layer may be disposed between the protective coating and the glass substrate. The coated article may form a portion of an insulating glass window unit.

In certain example embodiments, the organic material comprises an alkyl chain or a fluoro-alkyl chain and at least one reactive functionality comprising silicon and/or phosphorous comprises octadecyl trichlorosilane, octadecyl triethoxy silane, methyl trichlorosilane, a dipodal silane having dual reactive sites, bis(triethoxysilyl)decane, tridecafluoro tetrahydrooctyl trichlorosilane, tridecafluoro tetrahydrooctyl triethoxy silane, octadecyl phosphonic acid, methyl phosphonic acid, a fluorinated polyether, a perfluoropolyether containing reactive silane groups, a perfluoropolyether based polyurethane dispersion, a diphosphate derivative of perfluoropolyether, and/or a microemulsion of hydroalcoholic perfluoropolyether.

In certain example embodiments, the protective coating has a thickness sufficiently thin such that the protective coating has little or no impact on an optical performance of the first surface mirror.

In certain example embodiments, there is a solar collector that includes a first surface mirror. In certain example embodiments, there is a projection television that includes a first surface mirror.

### BRIEF DESCRIPTION OF THE DRAWINGS

FIG. 1 is a schematic diagram of a conventional first surface mirror.

FIG. 2 is a schematic diagram of a conventional solar collector system.

FIG. 3 is a cross sectional view of the second surface mirror used in the conventional solar collector system of FIG. 1.

FIG. 4 is a cross sectional view of a conventional projection television including a mirror.

FIG. 5A is a plan view of a first surface mirror on a support according to an example embodiment of this invention.

FIG. 5B is a plan view of a first surface mirror on a support according to another example embodiment of this invention.

FIG. 6 is a cross sectional view of a first surface mirror according to an example embodiment of this invention.

FIG. 7 is a cross sectional view of a first surface mirror according to an example embodiment of this invention.

FIG. 8 is a cross sectional view of a first surface mirror according to an example embodiment of this invention.

FIG. 9 is a cross sectional view of a first surface mirror according to an example embodiment of this invention.

FIG. 10 shows the reflection spectra measured at 45 degrees from first surface mirror mentioned above with and without a protective coating.

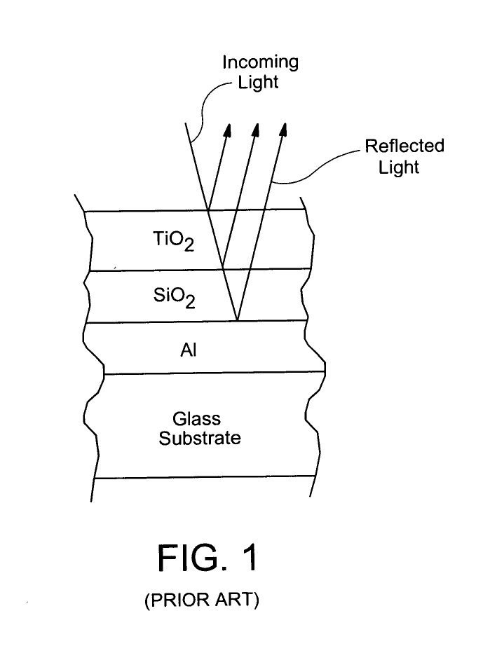

### DETAILED DESCRIPTION OF EXAMPLE EMBODIMENTS OF THE INVENTION

Referring now more particularly to the accompanying drawings in which like reference numerals indicate like parts throughout the several views.

Certain example embodiments of this invention relate to a first-surface mirror (FSM) that may be used in applications such as one or more of: parabolic-trough power plants, compound parabolic concentrating collectors, solar dish-engine systems, solar thermal power plants, and/or solar collectors, which rely on mirror(s) to reflect and direct solar radiation from the sun. In certain example instances, the mirror(s) may be mounted on a steel or other metal based support system. Certain example embodiments relate to optoelectronic devices, such as projection televisions. Rather than reflect solar radiation, these mirrors reflect light emitted from light sources so as to project an image on or through a screen or panel.

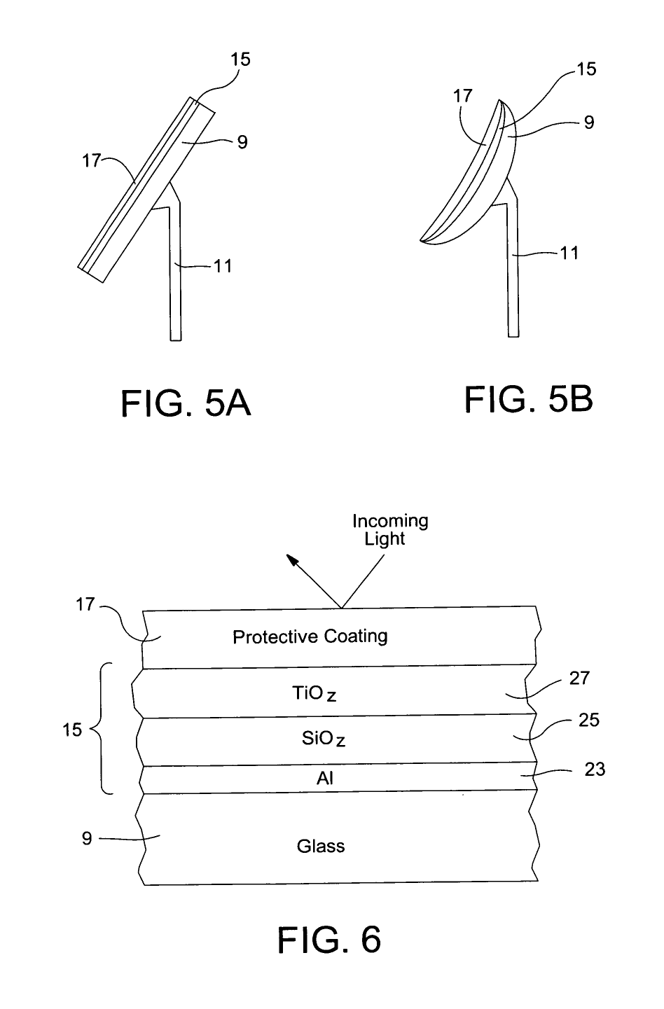

In certain example embodiments shown in FIGS. 5A-9, the FSM mirror includes a reflective coating 15 of one or more layers that is supported by a glass substrate 9. The reflective coating 15 preferably includes at least one reflective layer (e.g., Al, Ag, Cr, and/or the like).

FIGS. 5A and 5B are side cross sectional views of first surface mirrors according to certain example embodiments of this invention. FIG. 5A illustrates that the FSM may be flat in certain example embodiments, while FIG. 5B illustrates that the FSM may be parabolic in shape as to its reflective surface in other example embodiments of this invention. The FSMs of FIGS. 5A and 5B each include a glass substrate 9 mounted on a support system 11 made of steel or the like. The support system 11 may be rigid or adjustable/movable in different instances, but in any event supports at least the glass substrate 9 of the mirror. The glass substrate 9 may be about 3-10 mm thick, and more preferably from about 3-6 mm thick, but may be other thickness in alternative example embodiments of this invention. The mirror includes the glass substrate 9 which supports each of a reflective coating 15 and a protective coating 17. As will be explained herein, the protective coating 17 is initially applied over the reflective coating 9 in a wet form, but is solid in the final product due to curing or the like. This mirror is referred to as a first-surface mirror or FSM because the reflective coating 15 is provided on the front surface of the glass substrate 9 so that incoming light from the sun or other source is reflected by the reflective coating 15 before it passes through the glass substrate 9. The reflective coating 15 may include one or more layers, at least one of which reflects incoming radiation from the sun or other source of radiation.

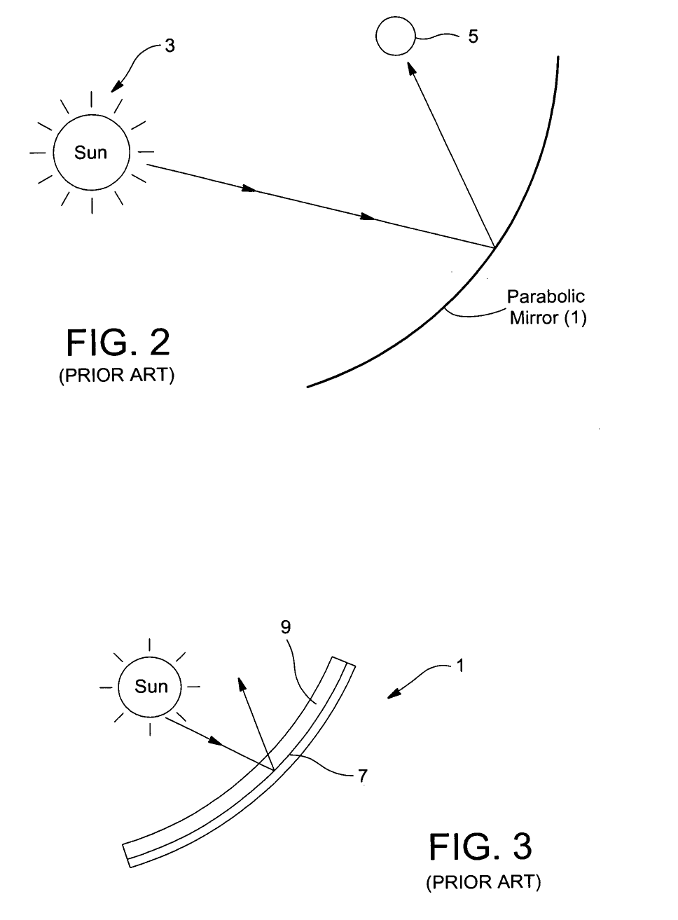

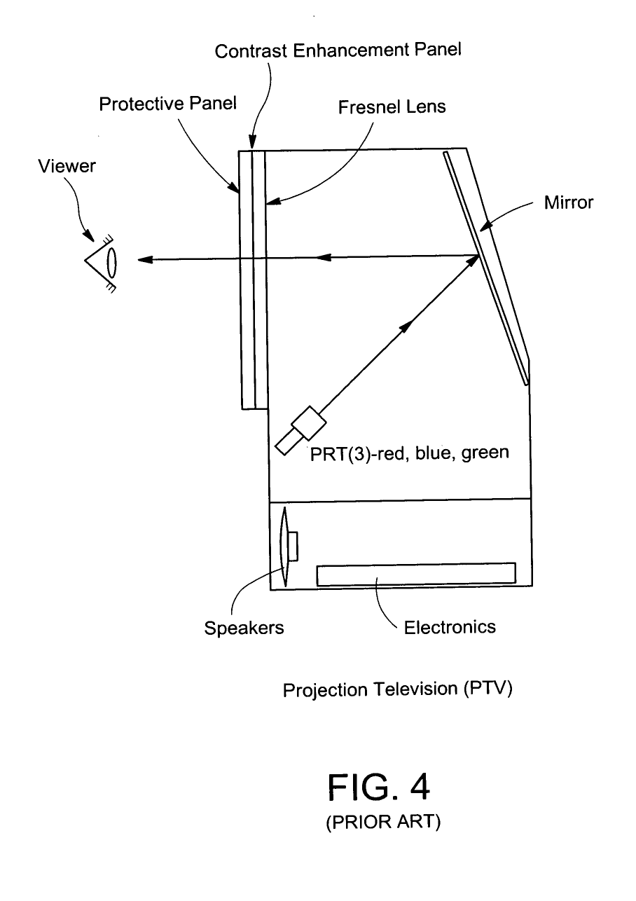

Different types of reflective coatings 15 may be used in the FSM in different example embodiments of this invention. For purposes of example only, FIGS. 6-9 illustrate different types of reflective coating 15 that may be used in a FSM according to example embodiments of this invention. The FSMs of FIGS. 6-9 may be used in the solar collector system of FIG. 2, the projection television system of FIG. 4, and/or may be used in any of the FSM applications discussed herein or as shown in FIGS. 5A and 5B.

FIG. 6 is a cross sectional view of a first surface mirror (FSM) according to an example embodiment of this invention. The mirror of this example includes glass substrate I that supports a multi-layer reflective coating 15 including reflective layer 23, first dielectric layer 5 and second dielectric layer 27. Protective coating 17, of one or more layers, is provided on the substrate 9 over the reflective coating 15. Substrate 9 is preferably glass, but may be of plastic or even metal in certain instances. With respect to the reflective coating 15, the reflective layer 23 provides the main reflection, while dielectric layers 25, 27 work together to enhance the reflection and tune the spectral profile to the desired wavelength region. Example non-limiting materials for the dielectric layers 25, 27 are shown in FIG. 6. Optionally, another dielectric layer(s) (not shown) such as tin oxide and/or silicon oxide may be provided on the substrate under the reflective layer 23 so as to be located between substrate 9 and reflective layer 23 in order to promote adhesion of the reflective layer 23 to the substrate in certain alternative embodiments of this invention. According to other alternative embodiments, additional dielectric layer(s) (not shown) may be provided over the reflective layer 23 so as to be provided between layer 23 and dielectric layer 25. In other example embodiments, as part of coating 15 another silicon oxide layer (e.g., SiO₂) and another titanium oxide layer (e.g., TiO₂) may be stacked on top of layers 23-27 in this order so that four dielectric layers are provided instead of the two shown for reflective coating 15. In still further embodiments of this invention, layer 27 and/or layer 25 may be eliminated.

Those skilled in the art will appreciate that the term “between” as used herein does not mean that a layer between two other layers has to contact the other two layers (i.e., layer A can be “between” layers B and C even if it does not contact layer(s) B and/or C, as other layer(s) can also be provided between layers B and C). Similarly, those skilled in the art will appreciate that term “on” as used herein does not mean directly contacting and that other layer(s) may be provided underneath a layer considered “on” another layer or substrate. For example, the protective coating is on the glass substrate, even though there are reflective layer(s) between the protective coating and the substrate.

Glass substrate 9 may be from about 1-10 mm thick in different embodiments of this invention, and may be any suitable color (e.g., grey, clear, green, blue, etc.). In certain example instances, glass (e.g., soda lime silica type glass) substrate 9 is from about 3-10 mm thick, most preferably about 3-6 mm thick. When substrate 9 is glass, it has an index of refraction value “n” of from about 1.48 to 1.53 (most preferably about 1.51) (all indices “n” herein are at about 550 nm).

Reflective layer 23 of the reflective coating 15 may be of or include Al, Ag or any other suitable reflective material in certain embodiments of this invention. Reflective layer 23 reflects the majority of incoming light before it reaches glass substrate 9 and directs it toward a collection area away from the glass substrate, so that the mirror is referred to as a first surface mirror. In certain embodiments, reflective layer 23 has an index of refraction value “n” of from about 0.05 to 1.5, more preferably from about 0.05 to 1.0. When layer 23 is of Al, the index of refraction “n” of the layer 23 may be about 0.8, but it also may be as low as about 0.1 when the layer 23 is of or based on Ag. In certain example embodiments of this invention, a metallic layer 23 of Al may be sputtered onto the substrate 9 using a C-MAG rotatable cathode Al inclusive target (may or may not be doped) and/or a substantially pure Al target (>=99.5% Al) (e.g., using 2 C-MAG targets, Ar gas flow, 6 kW per C-MAG power, and pressure of 3 mTorr), although other methods of deposition for layer 23 may be used in different instances. In sputtering embodiments, the target(s) used for sputtering Al layer 23 may include other materials in certain instances (e.g., from 0-5% Si to help the Al bond to substrate 9 and/or layer 25). Reflective layer 23 in certain embodiments of this invention has a reflectance of at least 75% in the 500 nm region as measured on a Perkin Elmer Lambda 900 or equivalent spectrophotometer, more preferably at least 80%, and even more preferably at least 85%, and in some instances at least about 90% or even 95%. Moreover, in certain embodiments of this invention, reflective layer 23 is not completely opaque, as it may have a small transmission in the visible and/or IR wavelength region of from 0.1 to 5%, more preferably from about 0.5 to 1.5%. Reflective layer 23 may be from about 20-150 nm thick in certain embodiments of this invention, more preferably from about 40-90 nm thick, even more preferably from about 50-80 nm thick, with an example thickness being about 65 nm when Al is used for layer 23.

Still referring to the FIG. 6 embodiment, first dielectric layer 25 may be of or include silicon oxide (e.g., approximately stoichiometric SiO₂ or any suitable non-stoichiometric oxide of silicon) in certain embodiments of this invention. Such silicon oxide may be sputtered onto the substrate 9 over layer 23 using Si targets (e.g., using 6 Si C-MAG targets, 3 mTorr pressure, power of 12 kW per C-MAG, and gas distribution of about 70% oxygen and 30% argon). In certain embodiments, first dielectric layer 25 has an index of refraction value “n” higher than that of layer 23, and preferably from 1.2 to 2.2, more preferably from 1.3 to 1.9, even more preferably from 1.4 to 1.75. For example, silicon oxide having an index of refraction of about 1.45 can be used for first dielectric layer 25 in certain example embodiments of this invention. First dielectric layer 25 may be from about 10-200 nm thick in certain embodiments of this invention, more preferably from about 50-150 nm thick, even more preferably from about 70-110 nm thick, with an example thickness being about 90 nm when the layer is of silicon oxide.

Second dielectric layer 27 in the FIG. 6 embodiment may be of or include titanium oxide (e.g., approximately stoichiometric TiO₂, or any suitable non-stoichiometric type of titanium oxide) in certain embodiments of this invention. Such titanium oxide may be sputter coated onto the substrate over layers 23 and 25 using Ti targets (e.g., 6 Ti C-MAG targets, pressure of 3.0 mTorr, power of 42 kW per C-MAG target, and a gas flow of about 60% oxygen and 40% argon). In certain embodiments, second dielectric layer 27 has an index of refraction “n” higher than that of layers 23 and/or 25, and preferably from 2.0 to 3.0, more preferably from 2.2 to 2.7, even more preferably from 2.3 to 2.5. For example, titanium oxide having an index of refraction value “n” of about 2.4 can be used for second dielectric layer 27 in certain example embodiments of this invention. Other suitable dielectrics may also be used in the aforesaid index of refraction range. Second dielectric layer 27 may be from about 10-150 nm thick in certain embodiments of this invention, more preferably from about 20-80 nm thick, even more preferably from about 20-60 nm thick, with an example thickness being about 40 nm when the layer is titanium oxide. As will be appreciated by those skilled in the art, layers 25 and 27 (and coating 17) are substantially transparent to visible light and much IR radiation so as to enable visible light and IR radiation to reach reflective layer 23 before being reflected thereby. In certain example embodiments, each of layers 23-27 may be sputter coated onto the substrate 9.

The protective coating 17 (which may be the outermost layer of mirror in certain example embodiments) is formed as follows in certain example embodiments of this invention. The protective coating is preferably applied in a wet form over the reflective coating 15, and is preferably dried at low temperature (e.g., room temperature).

In certain embodiments, the protective coating comprises an alkyl chain or a fluoro-alkyl chain and at least one reactive functionality comprising silicon and/or phosphorous. This may include, for example, short and long alkyl chains that may or may not contain fluorine. In some embodiments, reactive functionalities are optional but preferable in order to chemically bond the organic materials to the surface of the first surface mirror. In certain embodiments, there may be more than one alkyl chain attached to one reactive functionality or vice-versa.

Examples of preferred organic materials containing alkyl chains or fluoro-alkyl chains and reactive functionalities comprising silicon and/or phosphorous for the surface treatment layer may include octadecyl trichlorosilane, octadecyl triethoxy silane, methyl trichlorosilane, dipodal silanes having dual reactive sites, such as bis(triethoxysilyl)decane, tridecafluoro tetrahydrooctyl trichlorosilane, tridecafluoro tetrahydrooctyl triethoxy silane (available from Gelest), octadecyl phosphonic acid, methyl phosphonic acid (available from Alfa Aesar), etc. Other examples of preferred materials may include fluorinated polyether materials available from Solvay Solexis, such as perfluoropolyethers containing reactive silane groups (Fluorolink S10), perfluoropolyether based polyurethane dispersions (Fluorolink P56), diphosphate derivatives of perfluoropolyether in acid form or as ammonium salt (Fluorolink F10 and F10A) (see http://www.solvaysolexis.com/products/bybrand/brand/0,,16051-2-0,00.htm), microemulsions of hydroalcoholic perfluoropolyether (Fomblin FE20C), Fomblin Z derivatives used for magnetic disk protection, etc., (http://www.solvaysolexis.com/products/bybrand/brand/0,,16048-2-0,00.htm).

Dilute solutions or dispersions of coating materials in aqueous or non-aqueous media may be applied by any conventional wet application techniques. A preferred method involves application of a dilute coating formulation by spray process on the surface of the first surface mirror, e.g., immediately after the coated glass emerges from a vacuum coater. Concentration of spray coating formulation and the dwell time of the wet coating on the mirror surface may be varied to get maximum packing density of monolayers. In addition thermal energy may be applied to further enhance the coating process.

The uncured coating may be deposited in any suitable manner, including, for example, dip-coating, spin-coating, roller-coating, spray-coating, and any other method of depositing the uncured coating on a substrate.

In certain exemplary embodiments, the surface treatment composition includes (a) an organic material comprising an alkyl chain or a fluoro-alkyl chain and at least one reactive functionality comprising silicon and/or phosphorous and (b) a solvent.

In first surface mirror applications, it may be important that the protective top layer does not alter the overall optical characteristics and adversely affect reflection properties. Thus thickness and refractive index of protective top coat may be important and it is preferable that the protective top coat is applied as a very thin layer from materials that form coatings having minimum absorption in the interested wavelength range. It is also preferable that the refractive index of the protective coating is similar to the outermost layer applied atop reflective coating.

Preferably the surface treatment composition is dilute and has a molarity between 0.0001 and 0.01M (and all subranges therebetween); more preferably between 0.002 and 0.008M (and all subranges therebetween); and even more preferably between 0.004 and 0.006M (and all subranges therebetween). In accordance with certain embodiments of the present invention, suitable solvents may include, for example, n-propanol, isopropanol, other well-known alcohols (e.g., ethanol), and other well-known organic solvents (e.g., toluene).

In exemplary embodiments, the surface treatment composition may be optionally comprise solvents, anti-foaming agents, surfactants, etc., to adjust rheological characteristics and other properties as desired. In a preferred embodiment, use of reactive diluents may be used to produce formulations containing no volatile organic matter. Some embodiments may comprise colloidal silica dispersed in monomers or organic solvents.

In certain embodiments, the protective coating (after curing) is thin, e.g., less than 50 nm, less than 40 nm, less than 30 nm, less than 20 nm, less than 10 nm, less than 5 nm, less than 2 nm, or even less than 1 nm. That is, in certain embodiments, the protective coating may sufficiently thin that its existence has little (or no) impact on the optical performance of the substrate to which it is applied. In certain embodiments, for example, the protective coating may not substantially affect the percent transmission and/or percent reflection of the coated substrate (e.g., first surface mirror).

While the silica based protective coating 17 is formed via the technique in certain example embodiments as described above and below, it is also possible to form the coating 17 via CVD or sputtering in other example instances.

In applications where a focusing mirror is desired (e.g., see FIGS. 3 and 5B), the glass 9 may be bent as desired before or after application of the coating 15 and/or 17 in different embodiments of this invention.

The visible transmission and/or the Tsolar transmission of the protective coating 17 is/are at least about 80%, more preferably at least about 85%, and most preferably at least about 90% or 95% in certain example embodiments of this invention. Thus, not much radiation is absorbed by the protective coating 17 thereby permitting more radiation to reach the item/body to be heated in solar collector applications for example.

By arranging the respective indices of refraction “n” of layers 23-27 and coating 17 as discussed above, it may be possible to achieve both a scratch resistant and thus durable first surface mirror where it is difficult to scratch protective layer 9, and good anti-reflection properties to permit the mirror's optical performance to be satisfactory. The provision of protective coating 17 that is durable and scratch resistant, and highly transparent to visible and IR radiation, and has a good index of refraction, enables the combination of good durability and good optical performance to be achieved. The first surface mirror may have a Total Solar (Tsolar) reflection and/or visible reflection of at least about 80%, more preferably of at least about 85%, and even at least about 90% or 95% in certain embodiments of this invention.

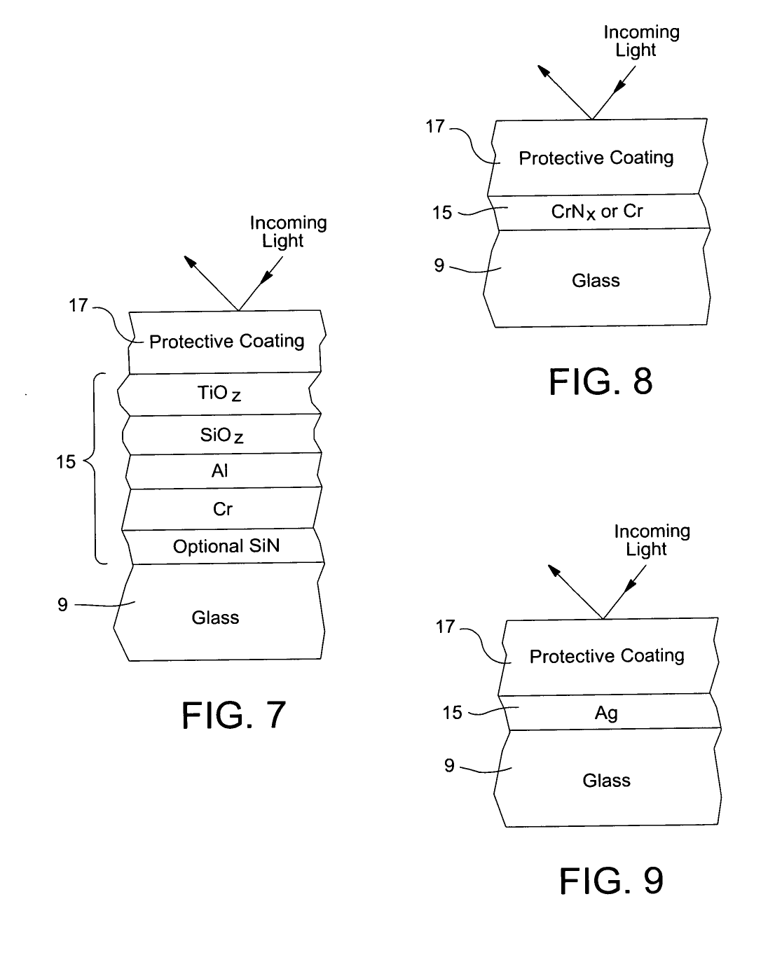

The reflective coatings 15 shown in FIG. 6 and discussed above are provided for purposes of example only, and other types of reflective coatings 15 may instead be used. FIGS. 7-9 illustrate other types of example reflective coatings 15 that may be used in FSMs according to different example embodiments of this invention. For purposes of example, the reflective coating 15 in any embodiment of this invention may be made up of any of the reflective coatings described in any of U.S. Pat. No. 7,276,289 or U.S. application Ser. No. 10/959,321, the disclosures of which are hereby incorporated herein by reference. Moreover, the reflective coating 15 in any embodiment of this invention may be made up of any of the reflective coatings described in any of U.S. Pat. Nos. 6,783,253 or 6,934,085, the disclosures of which are hereby incorporated herein by reference.

FIG. 7 illustrates another example reflective coating 15 that may be used in a FSM according to an example embodiment of this invention. The protective coating 17 discussed above is provide on the glass substrate 9 over the reflective coating 15 shown in the FIG. 7 embodiment. In the FIG. 7 embodiment, both the Al and Cr layers function as reflective layers. The layers of the reflective coating 15 in the FIG. 7 embodiment are preferably deposited via sputtering, although other techniques may instead be used.

FIG. 8 illustrates another example reflective coating 15 that may be used in a FSM according to an example embodiment of this invention. The protective coating 17 discussed above is provide on the glass substrate 9 over the reflective coating 15 shown in the FIG. 8 embodiment. In the FIG. 8 embodiment, the reflective coating 15 is made up of a single reflective layer of Cr or a nitride thereof. Optional dielectric layers (not shown) need not be provided. The Cr/CrN reflective layer of the reflective coating 15 in the FIG. 8 embodiment may be deposited via sputtering.

FIG. 9 illustrates another example reflective coating 15 that may be used in a FSM according to an example embodiment of this invention. The protective coating 17 discussed above is provide on the glass substrate 9 over the reflective coating 15 shown in the FIG. 7 embodiment. In the FIG. 9 embodiment, the reflective coating 15 includes or is made up of a silver based layer that may be initially applied in wet or solid form. For instance, the reflective coating 15 may be formed by sensitizing and activating the substrate 9, and then silvering the substrate to provided a silver based layer thereon. The activating of the substrate may be performed by contacting the substrate with a solution including ion(s), and the subsequent silvering may be achieved by spraying a silvering solution onto the sensitized and activated substrate 9 to form a silver based coating 15. Copper may or may not be used. Then, after the reflective coating with the silver layer is formed, the protective coating 17 is formed as explained above.

Although described above with respect to first surface mirrors, the protective coating may be applied to a number of different substrates and used in a number of different applications. For example, the protective coating may be used in conjunction with a low-E coating, such as those applied to an IG window unit.

IG window units are known in the art, including, for example, those described in U.S. Pat. Nos. 6,632,491 and 6,946,171, the disclosures of which are hereby incorporated herein by reference. An IG window unit generally includes at least first and second substrates spaced apart from one another by at least one spacer and/or seal. The gap or space between the spaced apart substrates may be filled with a gas (e.g., argon) and/or may be evacuated to a pressure less than atmospheric pressure in different instances.

Many conventional IG window units include a solar management coating (e.g., a multi-layer coating for reflecting at least some infrared radiation) on an interior surface of one of the substrates. Example solar management or control coatings are described in U.S. Pat. Nos. 6,632,491, 6,926,967, 6,908,679, 6,749,941, 6,782,718, 6,576,349, and 7,090,921, the disclosures of which are hereby incorporated herein by reference. Such IG units may facilitate the blocking of significant amounts of infrared (IR) radiation, which may reduce the amount of IR radiation reaching the interior of the building (e.g., apartment, house, office building, etc.), via the solar control/management coating(s). Some conventional IG window units also include a coating for blocking ultraviolet (UV) radiation on the interior surface of one of the substrates. A protective layer in accordance with certain embodiments of the present invention may be applied to any of the surfaces of the substrates forming the IG window unit, including those surfaces including solar management layer(s) and/or UV blocking layer(s).

An example in accordance with an exemplary embodiment of the present invention was prepared as follows.

A first surface mirror was prepared. The first surface mirror consisted of a 4 mm thick soda lime glass coated with, in order, a first layer of 40 nm of aluminum and a second layer of 80 nm of silicon dioxide, and third layer of 40 nm of titanium dioxide. These layers were deposited by magnetron sputtering in a vacuum.

A protective coating solution was prepared. The solution contained Fluorolink F10A from Solvay Solexis and was an aqueous emulsion containing 1% fluorinated polymer. This protective coating solution was applied using the dip coating process, then air dried at ambient temperature.

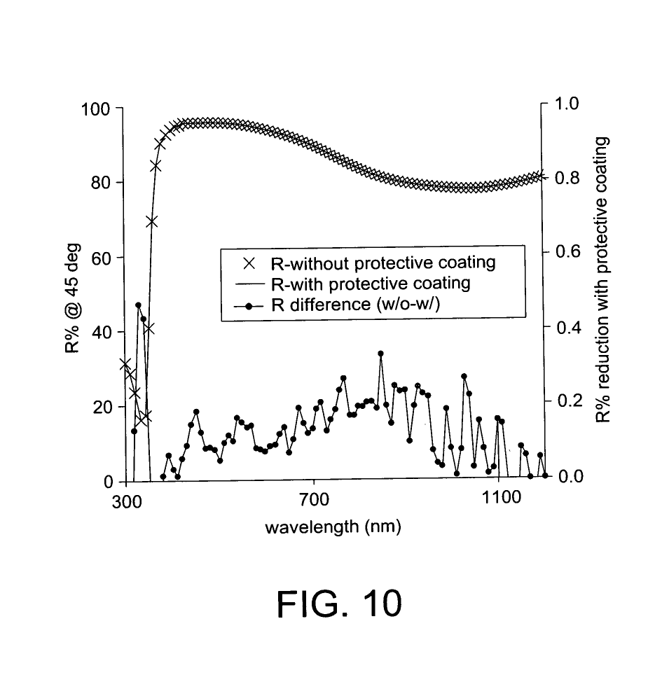

FIG. 10 shows the reflection spectra measured at 45 degrees from first surface mirror described herein with and without a protective coating. The reflection spectra on FSM with and without low friction coating were measured at 45 degree by a PerkinElmer 900 spectrometer. Results show the difference between these two spectra is very little (as shown in FIG. 10). This shows that the low friction coating can be so thin that its existence only reduces friction and has little (or no) impact on the optical performance of the optical coating to which it is applied.

That is, FIG. 10 shows the protective coating may have only ignorable impact on mirror optical performance, and at the same time, provides improved lubricant and hydrophobic surface as shown in Table 1.

TABLE 1
Surface energy of soda lime glass and first surface mirror with
and without protective coating measured by liquid dyne pens.

| | | | Glass/FSM/Protective |
|---|---|---|---|
| | Soda Lime Glass | Glass/FSM | Coating |
| Surface Energy | 65 | 33 | >70 |
| (dyne-cm) | | | |

The surface energy results in Table 1 were generated by using a Accu Dyne Test Marker Pens fabricated by Diversified Enterprises. Discontinued ink spots, and not continuous lines were drawn. These marker pens have a series of different inks having different surface energies. Through observing the wetness of marks left on coating surface by different marker pens, one can identify the surface energy of coating. For example, a high light pen can mark a line with ease on regular paper, but not on the oily paper; this means that the oily paper has a higher surface energy than the regular paper.

All described and claimed numerical values and ranges are approximate and include at least some degree of variation.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, the coatings discussed herein may in some instances be used in back surface mirror applications, different materials may be used, additional or fewer layers may be provided, and/or the like.

1. A method of making a first surface mirror, the method comprising:
forming a reflective coating on a glass substrate;
forming a protective coating on the glass substrate over the reflective coating, the protective coating being formed from a protective coating composition comprising at least one organic material containing an alkyl chain or a fluoro-alkyl chain and at least one reactive functionality comprising silicon and/or phosphorous.

2. The method of claim 1, wherein the organic material containing an alkyl chain or a fluoro-alkyl chain and at least one reactive functionality comprising silicon and/or phosphorous comprises octadecyl trichlorosilane, octadecyl triethoxy silane, methyl trichlorosilane, a dipodal silane having dual reactive sites, bis(triethoxysilyl)decane, tridecafluoro tetrahydrooctyl trichlorosilane, tridecafluoro tetrahydrooctyl triethoxy silane, octadecyl phosphonic acid, methyl phosphonic acid, a fluorinated polyether, a perfluoropolyether containing reactive silane groups, a perfluoropolyether based polyurethane dispersion, a diphosphate derivative of perfluoropolyether, and/or a microemulsion of hydroalcoholic perfluoropolyether.

3. The method of claim 1, wherein the protective coating composition comprises octadecyl phosphonic acid.

4. The method of claim 1, wherein the protective coating composition comprises a fluorinated polyether.

5. The method of claim 1, wherein the protective coating composition further comprises a solvent and has a molarity ranging between 0.0001 and 0.01M.

6. The method of claim 1, wherein the protective coating composition further comprises a solvent and has a molarity ranging between 0.002 and 0.008M.

7. The method of claim 1, wherein the protective coating has a thickness less than 50 nm.

8. The method of claim 1, wherein the protective coating has a thickness less than 10 nm.

9. The method of claim 1, wherein the protective coating has a thickness less than 5 nm.

10. The method of claim 1, wherein the protective coating has a thickness sufficiently thin such that the protective coating has little or no impact on an optical performance of the first surface mirror.

11. The method of claim 1, wherein the first surface mirror has a percent transmission and/or percent reflection that is not substantially affected by the protective coating comprising the organic material comprising an alkyl chain or a fluoro-alkyl chain and at least one reactive functionality comprising silicon and/or phosphorous.

12. A solar collector comprising the first-surface mirror made by the method of claim 1.

13. A projection television comprising the first-surface mirror made by the method of claim 1.

14. A first surface mirror, comprising:
a reflective coating supported by a glass substrate; and
a protective coating provided on the glass substrate over the reflective coating of the first surface mirror;
wherein the protective coating comprises at least one organic material containing an alkyl chain or a fluoro-alkyl chain and at least one reactive functionality comprising silicon and/or phosphorous.

15. The first surface mirror of claim 14, wherein the organic material comprising an alkyl chain or a fluoro-alkyl chain and at least one reactive functionality comprising silicon and/or phosphorous comprises octadecyl trichlorosilane, octadecyl triethoxy silane, methyl trichlorosilane, a dipodal silane having dual reactive sites, bis(triethoxysilyl)decane, tridecafluoro tetrahydrooctyl trichlorosilane, tridecafluoro tetrahydrooctyl triethoxy silane, octadecyl phosphonic acid, methyl phosphonic acid, a fluorinated polyether, a perfluoropolyether containing reactive silane groups, a perfluoropolyether based polyurethane dispersion, a diphosphate derivative of perfluoropolyether, and/or a microemulsion of hydroalcoholic perfluoropolyether.

16. The first surface mirror of claim 14, wherein the protective coating composition comprises octadecyl phosphonic acid.

17. The first surface mirror of claim 14, wherein the protective coating composition comprises a fluorinated polyether.

18. The first surface mirror of claim 14, wherein the protective coating has a thickness less than 40 nm.

19. The first surface mirror of claim 14, wherein the protective coating has a thickness less than 20 nm.

20. The first surface mirror of claim 14, wherein the protective coating has a thickness less than 10 nm.

21. The first surface mirror of claim 14, wherein the protective coating has a thickness sufficiently thin such that the protective coating has little or no impact on an optical performance of the first surface mirror.

22. The first surface mirror of claim 14, wherein the first surface mirror has a percent transmission and/or percent reflection that is not substantially affected by the protective coating comprising the organic material comprising an alkyl chain or a fluoro-alkyl chain and at least one reactive functionality comprising silicon and/or phosphorous.

23. A solar collector comprising the first-surface mirror of claim 14.

24. A projection television comprising the first-surface mirror of claim 14.

25. A coated article, comprising:
a substrate; and
a protective coating provided on the substrate;
wherein the protective coating comprises at least one organic material containing an alkyl chain or a fluoro-alkyl chain and at least one reactive functionality comprising silicon and/or phosphorous.

26. The coated article of claim 25, wherein the substrate comprises a glass substrate.

27. The coated article of claim 26, wherein the glass substrate supports a solar management layer having low-emissivity properties.

28. The coated article of claim 27, wherein the solar management layer is disposed between the protective coating and the glass substrate.

29. The coated article of claim 25, wherein the coated article comprises a portion of an insulating glass window unit.
